(19) United States
(12) Patent Application Publication
(10) Pub. No.: US 2015/0006385 A1
(43) Pub. Date: Jan. 1, 2015

(54) EXPRESS TRANSACTIONS ON A MOBILE DEVICE

(71) Applicant: Tejas Arvindbhai Shah, Redmond, WA (US)

(72) Inventor: Tejas Arvindbhai Shah, Redmond, WA (US)

(21) Appl. No.: 13/931,672

(22) Filed: Jun. 28, 2013

(51) Int. Cl. G06Q 20/40; G06Q 20/32

(52) U.S. Cl. CPC G06Q 20/401; G06Q 20/322
USPC 705/44

(57) ABSTRACT

Methods and systems for facilitating express transactions, such as authentication and/or payment, on a mobile device are described. The methods include receiving an authentication request or payment request, receiving user input at a touch screen of a mobile device, comparing the user input to a gesture for authentication for login, or authentication and authorization of payment for a known user, and processing the authentication request or payment request if the user input matches the gesture.

### BACKGROUND

1. Field of the Invention

The present invention generally relates to performing transactions using a mobile device.

2. Related Art

Selection of various items from electronic catalogs is generally based on the “shopping cart” model. When the purchaser selects an item from the electronic catalog, the server computer system metaphorically adds that item to a shopping cart. When the purchaser is done selecting items, then all the items in the shopping cart are “checked out” (i.e., ordered) when the purchaser provides billing and shipment information. In some models, when a purchaser selects any one item, then that item is “checked out” by automatically prompting the user for the billing and shipment information. Although the shopping cart model may be flexible and intuitive, it has a downside in that it requires many interactions by the purchaser.

For example, the purchaser selects the various items from the electronic catalog, and then indicates that the selection is complete. The purchaser is then presented with an order web page that prompts the purchaser for the purchaser-specific order information to complete the order, such as name, address, and billing information. That web page may be prefilled with information that was provided by the purchaser when placing another order. After that web page, another web page with the entered information pops up, asking the purchaser to confirm all the information. Once the purchaser confirms, yet another web page appears that requests the purchaser to place the order.

Going through multiple screens can make it very difficult for a purchaser to finalize a transaction quickly. Thus, a need exists for systems and methods that are more efficient and convenient for the purchaser.

### BRIEF DESCRIPTION OF THE FIGURES

FIG. 1 is a block diagram illustrating a system for facilitating express payment or express authentication with a mobile device according to an embodiment of the present disclosure;

FIG. 2 is a flowchart showing a method for facilitating express payment with a mobile device according to an embodiment of the present disclosure;

FIG. 3 is a flowchart showing a method for facilitating express authentication or log in with a mobile device according to an embodiment of the present disclosure;

FIG. 4 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes the use of gestures in a one-step authentication and authorization method for payment, and/or one-step authentication for logging in to an account. A user signs up with a service provider and sets up a custom gesture, i.e., a touch screen motion that performs an action. The user draws, or otherwise provides the gesture, e.g., swirly mark or check mark, on the touch screen. The gesture is stored by the service provider and associated with the user. The gesture acts as the equivalent of the user entering his or her user name, password, and/or financial information. Whenever the user wants to make a purchase or log in to his or her account, all he or she needs to do is provide the gesture on the touch screen, and the purchase can be finalized, or he or she can be immediately authenticated, without the hassle of inputting names, passwords, addresses, and credit card information. In this way, the user can experience express buying/shopping express and/or express log in. Use of gesture-based confirmation enables the user to perform transactions on the go, such as when buying a ticket to rush onto a train or bus.

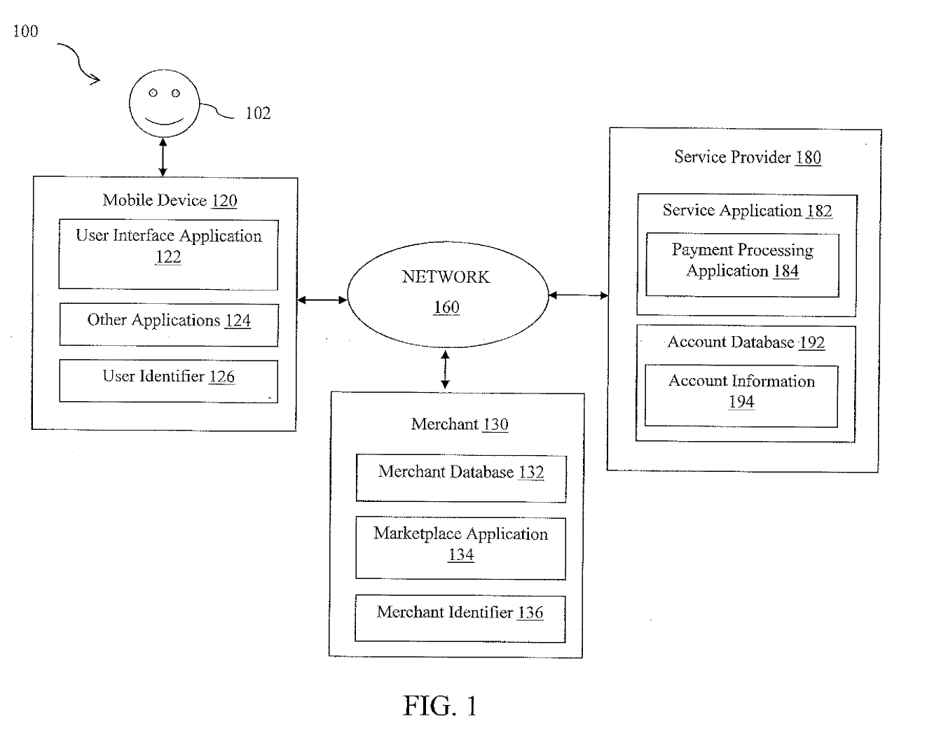

FIG. 1 shows one embodiment of a block diagram of a network-based system 100 adapted to facilitate express payment and/or express authentication using a mobile device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the mobile device 120, merchant servers or devices 130, and service provider server or device 180 may be associated with a particular link (e.g., a link, such as a URL (Uniform Resource Locator) to an IP (Internet Protocol) address).

The mobile device 120, in various embodiments, may be implemented using any appropriate combination of hardware and/or software configured for wired and/or wireless communication over the network 160. The mobile device 120, in one embodiment, may be utilized by the user 102 to interact with the service provider server 180 over the network 160. For example, the user 102 may conduct financial transactions (e.g., account transfers) with the service provider server 180 via the mobile device 120. In various implementations, the mobile device 120 may include at least one of a wireless cellular phone, personal digital assistant (PDA), satellite phone, etc.

In various embodiments, the mobile device 120 includes a touch screen. The touch screen detects an external touch event, such as a user using a finger or stylus to draw on the touch screen or perform other actions on the screen. The touch screen includes a display unit that displays menus, user input information, and information provided to user 102.

The mobile device 120, in one embodiment, includes a user interface application 122, which may be utilized by the user 102 to conduct transactions (e.g., shopping, purchasing, bidding, etc.) with the merchant server or device 130 or with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 220, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The mobile device 220, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 102 over the network 160. As such, each of the one or more merchant servers 130 may include a merchant database 132 for identifying available items, which may be made available to the mobile device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of service provider as a payment intermediary. The merchant website may also have an account with the service provider.

The service provider server 180, in one embodiment, may be maintained by a transaction processing entity, which may provide processing for financial transactions and/or information transactions between the user 102 and one or more of the merchant servers 130. As such, the service provider server 180 includes a service application 182, which may be adapted to interact with the mobile device 120 and/or each merchant server 130 over the network 160 to facilitate the searching, selection, purchase, and/or payment of items by the user 102 from one or more of the merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing application 184 settles indebtedness between the user 102 and each of the merchants 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 130). For example, account information 194 may include private financial information of user 102 and each merchant associated with the one or more merchant servers 130, such as one or more account numbers, passwords, credit card information, banking information, or other types of financial information, which may be used to facilitate financial transactions between user 102, and the one or more merchants associated with the merchant servers 130. In various aspects, the methods and systems described herein may be modified to accommodate users and/or merchants that may or may not be associated with at least one existing user account and/or merchant account, respectively.

In various embodiments, account information 194 includes custom gestures provided by user 102 for authentication of identity and authorization of payment. Gestures include hand drawn patterns, letters, numbers, shapes, symbols, drawings, or a combination thereof. Gestures can be combined into a series of multiple gestures to further enhance security. Gestures can also include tapping, pinching in and/or out, panning or dragging, swiping, rotating, and long press (“touch and hold”). Use of the gestures facilitates express transactions on the mobile device 120, and shortens the amount of time it takes to log in to an application or finalize a purchase transaction.

In one implementation, the user 102 may have identity attributes stored with the service provider server 180, and user 102 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

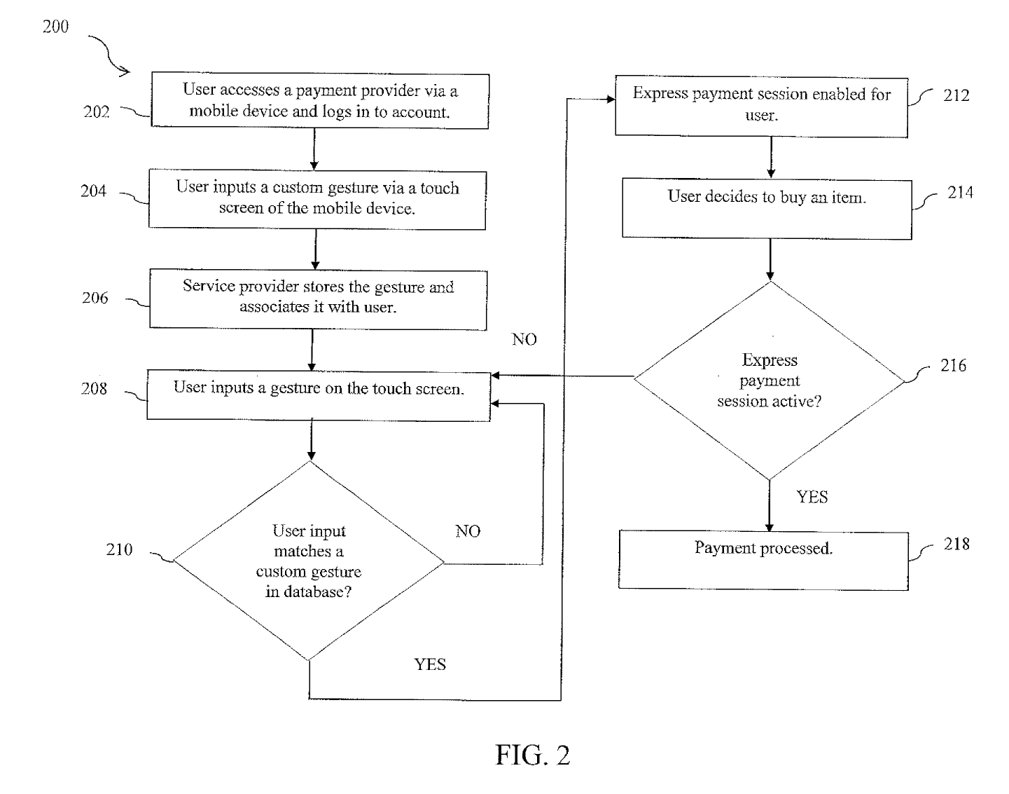

Referring now to FIG. 2, a flowchart of a method 200 for facilitating express payment with a mobile device is illustrated according to an embodiment of the present disclosure. In an embodiment, at step 202, user 102 accesses a service provider site via the mobile device 120, and logs in to his or her account. The user provides identifying data, e.g., user name, password, answers to security questions, etc.

At step 204, user 102 goes to his or her profile to select an alternative method of payment, e.g., the “express payment” option for quick payment, and inputs a custom gesture via a touch screen of mobile device 120. User 102 draws a single/multiple patterns or gestures as an alternate mode for payment using the express payment option. The touch screen detects the external touch actions performed by user 102 to set up a predetermined condition for authentication and authorization of payment. In one embodiment, the custom gesture includes a hand drawn pattern, picture, letter, number, symbol, etc., or a series of hand drawn patterns, pictures, letters, numbers, symbols, etc. Input of the custom gesture may be simultaneous or sequential. In other embodiments, the custom gesture includes a tap, pinch, swipe, etc. To avoid set up errors, user 102 may be requested to confirm if the custom gesture is correct. In one embodiment, the custom gesture is displayed to user 102, and user 102 confirms the set up is correct. If user 102 cancels the set up, user 102 is prompted to input a custom gesture again.

In some embodiments, during set up, the touch screen includes a plurality of set up points on the touch screen to allow user 102 to perform the touch setup. The quantity and location of the set up points may be any suitable configuration. In one embodiment, the set up points form a matrix of dots, and the custom gesture is a hand motion that defines a specific pattern on the dots. For example, user 102 can select certain dots and select the order that the certain dots must be touched. The matrix can generate a variety of different combinations. In other embodiments, the touch points form a circle, heart, star, polygon, or any other shape.

At step 206, the service provider stores the custom gesture and associates the gesture with user 102 and authorization of payment for user 102. Once the custom gesture is set up and stored, the user 102 is free to browse merchant websites and select items for express purchase.

When user 102 wants to quickly buy items using express payment, user 102 selects an express payment icon on mobile device 120. User 102 is then presented with a request for express payment authentication. At step 208, user 102 inputs or draws a gesture on the touch screen of mobile device 120. The service provider receives the user input.

At step 210, the user input is compared with a custom gesture for a known user, i.e., a user that had been previously identified and who set up a custom gesture. The service provider verifies if the user input is in its database. The service provider determines if the user input satisfies the predetermined condition for authentication and authorization of payment, that is, if the user input matches a custom gesture. If the user input does not match, user 102 is directed to input another gesture. If the user input does match, then express payment session is enabled for the user at step 212.

At step 214, user 102 decides to buy an item and clicks on a “buy item” button. The service provider receives the payment request. At step 216, a determination is made if the express payment session is still active. In some embodiments, the express payment session is active for a short period of time, e.g., from about 30 seconds to about 5-10 minutes, from the time the express payment session is enabled. Once the express payment session is enabled and active, user 102 can shop for as many items as he or she wants and from as many merchants as he or she wants, until the express payment session expires. The express payment session is not limited to a single transaction or the purchase of a single item.

If the express payment session is still active, then in step 218, payment of the item is processed. The item is purchased and payment is processed successfully without further action or input from user 102. After processing, the service provider may then transmit a notification to the user and/or the merchant.

If the user input does not match a custom gesture, the transaction may be rejected and user 102 prompted to input another gesture. In one embodiment, if the number of unsuccessful attempts exceeds a predetermined number, user 102 may be locked out from using the express payment option.

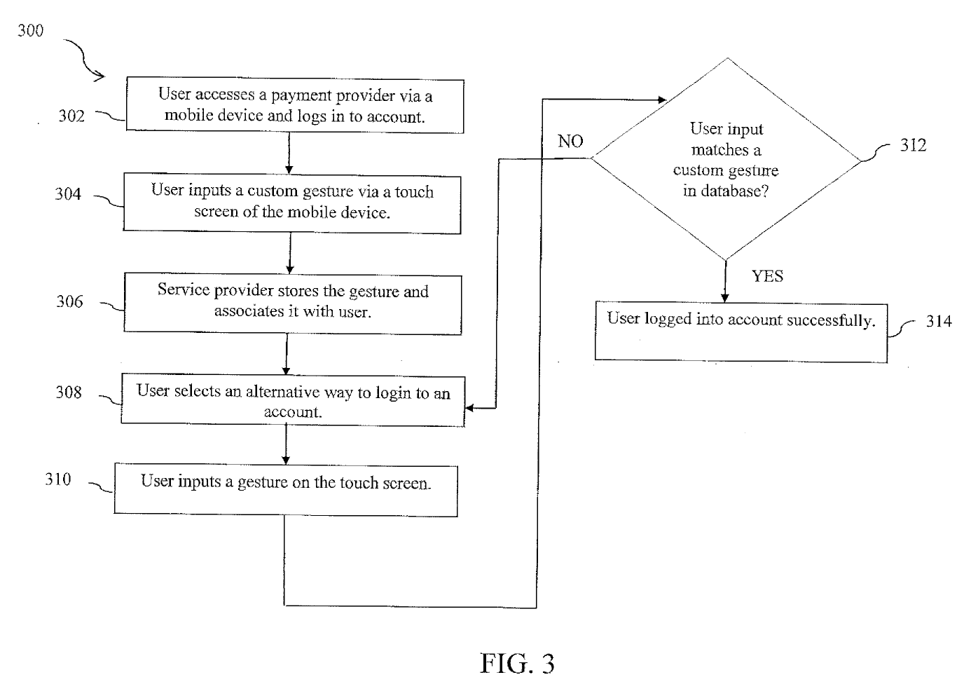

FIG. 3 is a flowchart 300 for facilitating express authentication with a mobile device. At step 302, user 102 logs in to his or her account on mobile device 120. At step 304, user 102 goes to his or her profile to select an alternative method of login, e.g., the “express login” option for quick login, and inputs a custom gesture via a touch screen of mobile device 120. User 102 draws a single/multiple patterns or gestures as an alternate mode to providing credentials during login. At step 306, the service provider stores the custom gesture and associates the gesture with user 102. Steps 302 through 306 are similar to steps 202 through 206 of FIG. 1, and thus, the details of these steps are omitted for brevity.

When user 102 wants to log in to his or her account, at step 308, user 102 selects an alternative way to login, e.g., the “express login” option, on mobile device 120. User 102 is then presented with a request for express login authentication. At step 310, user 102 inputs or draws a gesture on the touch screen of mobile device 120. The service provider receives the user input and the request for express authentication.

At step 312, the user input is compared with a custom gesture for a known user, i.e., a user that had been previously identified and who set up a custom gesture. The service provider verifies if the user input is in its database. The service provider determines if the user input satisfies the predetermined condition for authentication, that is, if the user input matches a custom gesture. If the user input does not match, user 102 is directed to select an alternative way to login to his or her account. If the user input does match, then the user is logged into his or her account successfully at step 212 without further action or input from user 102.

In some embodiments, user 102 has a limited amount of time to provide user input from the time the authentication request is received. If user 102 does not input the correct gesture within a given time period, the service provider may operate to cancel the transaction. In an exemplary embodiment, the user input must be received within about 15 to 30 minutes of the authentication request.

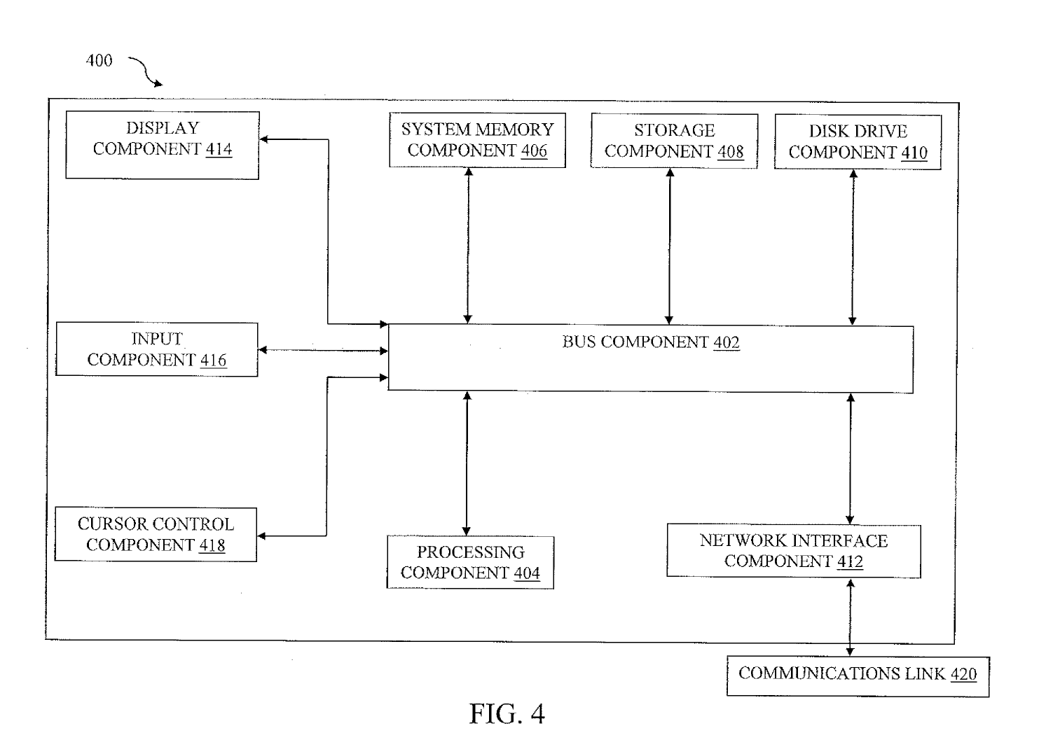

Referring now to FIG. 4, a block diagram of a system 400 is illustrated suitable for implementing embodiments of the present disclosure, including mobile device 120, one or more merchant servers or devices 130, and service provider server or device 180. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for facilitating express payment and/or express authentication using a mobile device.

Although various components and steps have been described herein as being associated with mobile device 120, merchant server 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user account information, wherein the user account information comprises a known user's gesture for authentication and authorization of payment, and/or authentication for login; and
one or more processors in communication with the memory device and operable to:
receive an authentication request or payment request;
receive user input at a touch screen of a mobile device;
compare the user input to the gesture of a known user; and
process the authentication request or payment request if the user input matches the gesture.

2. The system of claim 1, wherein the gesture comprises hand drawn patterns, pictures, letters, numbers, shapes, symbols, or a combination thereof.

3. The system of claim 2, wherein the gesture comprises a series of multiple gestures.

4. The system of claim 1, wherein the payment request must be received within a predetermined amount of time.

5. The system of claim 4, wherein the predetermined amount of time is about 30 seconds to about 10 minutes from a time express payment is enabled.

6. The system of claim 1, wherein the one or more processors is further operable to reject the authentication request or payment request if the user input does not match the gesture.

7. The system of claim 1, wherein the one or more processors is further operable to process the authentication request or payment request without additional action from the user.

8. A method for facilitating express transactions on a mobile device, comprising:
receiving, by one or more hardware processors of a service provider, an authentication request or payment request;
receiving user input at a touch screen of a mobile device;
comparing the user input to a gesture for authentication of login for a known user, or authentication and authorization of payment for a known user; and
processing the authorization request or payment request if the user input matches the gesture.

9. The method of claim 8, further comprising:
receiving a known user's gesture for authentication of login, or authentication and authorization of payment;
storing the gesture; and
associating the gesture with the known user.

10. The method of claim 8, wherein the gesture comprises hand drawn patterns, pictures, letters, numbers, shapes, symbols, or a combination thereof.

11. The method of claim 10, wherein the gesture comprises a series of multiple gestures.

12. The method of claim 8, wherein the payment request must be received within a predetermined amount of time.

13. The method of claim 8, further comprising rejecting the authentication request or payment request if the user input and gesture do not match.

14. The method of claim 8, wherein the authentication request or payment request is processed without additional action from the user.

15. A non-transitory machine-readable medium comprising a plurality of machine-readable instructions which, when executed by one or more processors, are adapted to cause the one or more processors to perform a method comprising:
receiving a known user's gesture for authentication of login, or authentication and authorization of payment;
storing the gesture;
associating the gesture with the known user;
receiving an authentication request or payment request;
receiving user input at a touch screen of a mobile device;
comparing the user input to a gesture of a known user; and
processing the authentication request or payment request if the user input matches the gesture.

16. The non-transitory machine-readable medium of claim 15, wherein the gesture comprises hand drawn patterns, pictures, letters, numbers, shapes, symbols, or a combination thereof.

17. The non-transitory machine-readable medium of claim 16, wherein the gesture comprises a series of multiple gestures.

18. The non-transitory machine-readable medium of claim 15, wherein the payment request must be received within a predetermined amount of time.

19. The non-transitory machine-readable medium of claim 15, wherein the method further comprises rejecting the authentication request or payment request if the user input and gesture do not match.

20. The non-transitory machine-readable medium of claim 15, wherein the authentication request or payment request is processed without additional action from the user.
